(19) United States
(12) Patent Application Publication
(10) Pub. No.: US 2008/0168071 A1
(43) Pub. Date: Jul. 10, 2008

(54) Storing Data in Predicted Formats

(76) Inventors: Pernell James Dykes, Byron, MN (US); William Thomas Newport, Rochester, MN (US); Jinmei Shen, Rochester, MN (US); Kevin William Sutter, Rochester, MN (US); Hao Wang, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/621,024

(22) Filed: Jan. 8, 2007

(51) Int. Cl. G06F 17/30

(52) U.S. Cl. 707/100; 707/E17.005

(57) ABSTRACT

In an embodiment, a request is received that includes data and a specification of a store operation, a key, and a local database. A predicted format for the data is determined based on a type of the requester and whether the local database is a primary database or a replica database. If the predicted format is a relational format, the data is converted to the relational format, if not already in the relational format, and stored into the local database. If a most-frequently predicted historical format is the relational format, the data is converted to the relational format, if not already in the relational format, and stored into the local database. If both the predicted format and the most-frequently predicted historical format are an object format, the data is converted into the object format, if not already in the object format, and stored into the local database.

### FIELD

An embodiment of the invention generally relates to computer systems and more specifically relates to predicting the format that users of data will need and storing the data in the predicted format.

### BACKGROUND

Fundamentally, computer systems are used for the storage, manipulation, and analysis of data. One mechanism for managing data is called a database management system, which may also be called a database system or simply a database. One common form of database is a relational database, which organizes data in tables that have rows, which represent individual entries, tuples, or records in the database, and columns, fields, or attributes, which define what is stored in each row, entry, or record. Each table has a unique name within the database and each column has a unique name within the particular table. The relational database also has an index, which is a data structure that identifies the location of a certain row in a table given an indexed column value, analogous to a book index informing the reader on which page a given word appears. The power of the relational database flows from the fact that the relational database model uses a mathematical representation for its data, where relationships exist within the data, but the data itself is not tied to any particular view of the data or method of accessing the data. Thus, accessing the data does not rely on any built-in navigational information within the data itself, and the actions, procedures, or modules that access the data are separate from the data. Thus, the relational data may be freely indexed, queried, and accessed as a whole.

Another form of database is an object-oriented database, which flows from an object-oriented programming model. Object-oriented databases organize data together with the actions (or methods) that are used to access the data. The data and methods are organized into objects. The object is said to encapsulate the data, and the data may only be accessed via the methods of its encapsulating object. The power of the object-oriented model flows from the simplification of the design process in creating object-oriented programs because people naturally think in terms of a subject performing an action on an object.

A problem arises because many new applications are written using the object-oriented programming model, but many existing databases are stored using the relational database model, and converting between the object-oriented model and the relational model is difficult and time-consuming. To make matters worse, data stored in objects is time-consuming to convert to a format that can be easily transmitted to another computer. Since data is often stored in replicas that exist at multiple servers, a change to a data item at a primary server may need to be replicated to multiple replica servers, which requires multiple conversion steps.

Thus, a better way is needed to format and replicate data.

### SUMMARY

A method, apparatus, system, and signal-bearing medium are provided. In an embodiment, a request is received that includes data and a specification of a store operation, a key, and a local database. A predicted format for the data is determined based on a type of the requester and based on whether the local database is a primary database or a replica database. If the predicted format is a relational format, the data is converted to the relational format, if not already in the relational format, and stored into the local database. In an embodiment, a most-frequently predicted historical format is calculated for historical requests that included the same key, and if the most-frequently predicted historical format is the relational format, the data is converted to the relational format, if not already in the relational format, and stored into the local database. If both the predicted format and the most-frequently predicted historical format are an object format, the data is converted into the object format, if not already in the object format, and stored into the local database. In an embodiment, if the requestor is a local object-oriented application and the local database is a primary database and replication of the operation is not needed, the predicted format is determined to be an object format. In an embodiment, if more than a threshold percentage of received requests are from local object-oriented applications and the local database is a primary database and replication of the operation is not needed, the predicted format is determined to be an object format.

In an embodiment, a request is received that includes a specification of a retrieve operation, a key, and a local database. Data is retrieved from the local database based on the key, and a predicted format is determined for the data based on the type of the requester and a mode of the local database. If the predicted format is the relational format, the data is sent to the requestor in the relational format. If the predicted format is the object format, the data is sent to the requester in the object format.

In this way, data is formatted, stored, and sent in predicted formats that increase the performance of data access.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a high-level block diagram of an example data structure for requests, according to an embodiment of the invention.

FIG. 3A depicts a high-level block diagram of an example system flag table, according to an embodiment of the invention.

FIG. 3B depicts a high-level block diagram of an example relational database, according to an embodiment of the invention.

FIG. 3C depicts a high-level block diagram of an example object oriented database, according to an embodiment of the invention.

FIG. 3D depicts a high-level block diagram of an example graph of data in the object oriented database, according to an embodiment of the invention.

FIG. 4 depicts a flowchart of example processing for requests, according to an embodiment of the invention.

FIG. 5 depicts a flowchart of example processing for retrieve operations, according to an embodiment of the invention.

FIG. 6 depicts a flowchart of example processing for store operations, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

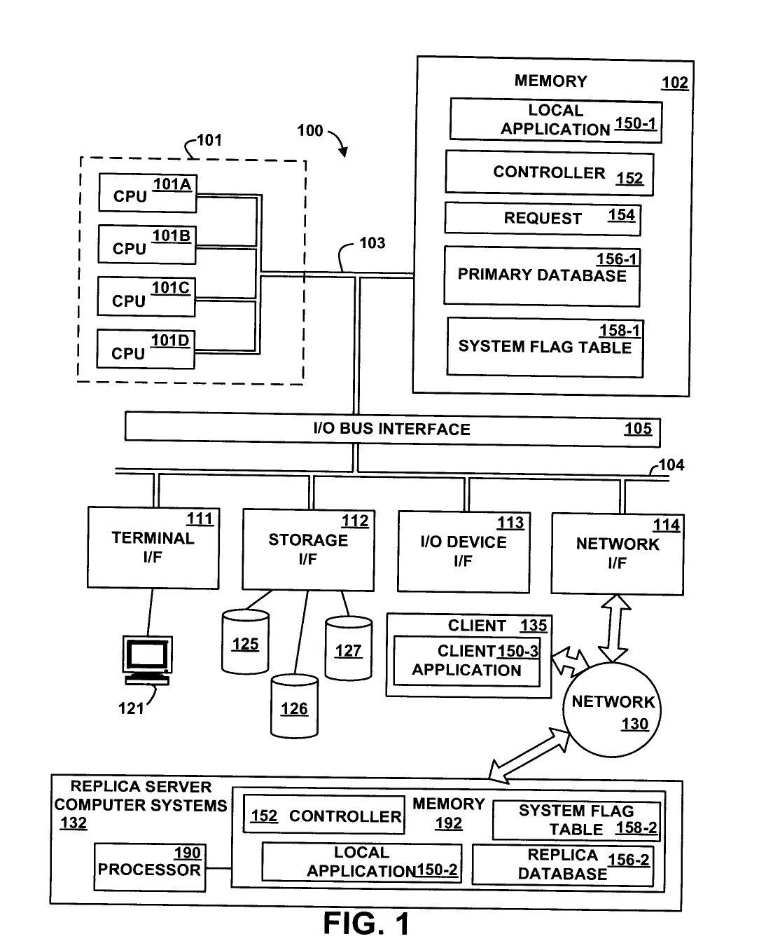

Referring to the Drawings, wherein like numbers denote like parts throughout the several views, FIG. 1 depicts a high-level block diagram representation of a primary server computer system 100 connected to replica server computer systems 132 and client computer systems 135 via a network 130, according to an embodiment of the present invention. The terms “primary,” “replica,” “client,” and “server” are used herein as labels that describe the various roles that the computer systems may assume and are included herein for convenience of exposition, only. In fact, in various embodiments, a particular computer system that acts in the role of a primary, a replica, a client, or a server in one scenario with respect to one data item may act as another role in another scenario with respect to another data item.

In an embodiment, the hardware components of the computer systems 100, 132, and 135 may be implemented by an eServer iSeries computer system available from International Business Machines Corporation of Armonk, N.Y. However, those skilled in the art will appreciate that the mechanisms and apparatus of embodiments of the present invention apply equally to any appropriate computing system.

The major components of the primary server computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the primary server computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a local application 150-1, a controller 152, a request 154, a primary database 156-1, and a system flag table 158-1. Although the local application 150-1, the controller 152, the request 154, the primary database 156-1, and the system flag table 158-1 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the local application 150-1, the controller 152, the request 154, the primary database 156-1, and the system flag table 158-1 are illustrated as being contained within the main memory 102, these elements are not necessarily all completely contained in the same storage device at the same time. Further, although the local application 150-1, the controller 152, the request 154, the primary database 156-1, and the system flag table 158-1 are illustrated as being separate entities, in other embodiments some of them, portions of some of them, or all of them may be packaged together.

The local application 150-1 sends requests, such as the request 154 to the controller 152. The local application 150-1 is local to the primary server computer system 100, in that the local application 150-l is stored at the primary server computer system 100 and executes on the processor 101 at the primary server computer system 100. The requests 154 may specify store (including create, update, and delete) and retrieve operations, which instruct the controller 152 to store/retrieve data to/from the primary database 156-1. In various embodiments, the primary database 156-1 may be a relational database or an object-oriented database. The controller 152 at the primary server 100 stores both relational data and object data into a relational database. The controller 152 at the primary server 100 further stores both relational data and object data into an object-oriented database. The controller 152 at the primary server 100 replicates changes (creates, updates, and deletes) that are made to the primary database 156-1 into the replica servers 132 by sending requests to the replica servers 132. The system flag table 158-1 indicates whether data stored in the primary database 156-1 is stored as relational data or object data.

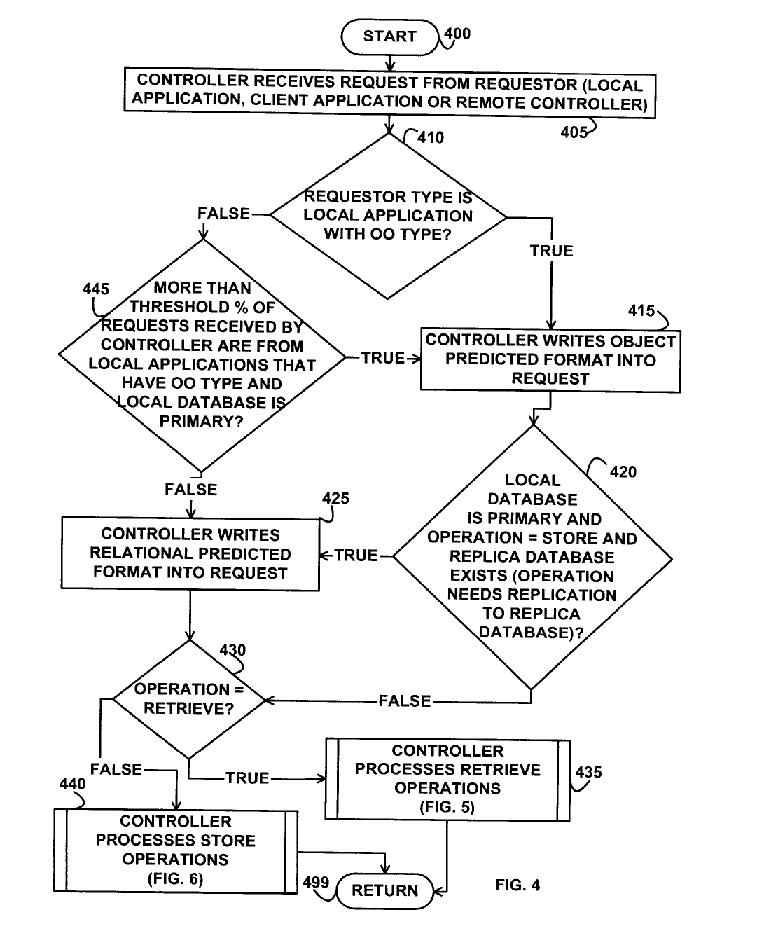

The local application 150-1 and the controller 152 include instructions capable of executing on the processor 101 or statements capable of being interpreted by instructions executing on the processor 101 to perform the functions as further described below with reference to FIGS. 4, 5, and 6.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121. The user terminal 121 may include a keyboard, video display terminal, speakers, a mouse or other pointing device, or any other input and/or output device via which a user can submit input and/or receive output to and/or from the computer system 100. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers, fax machines, or any other devices. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 maybe an IEEE 802.11B wireless network. In still another embodiment, the network 130 may be any suitable network or combination of networks. Although one network 130 is shown, in other embodiments any number of networks (of the same or different types) may be present.

The client computer system 135 may include some or all of the components as previously described above for the primary server computer system 100. In particular, the client computer system 135 includes a client application 150-3, which sends requests 154 to the primary server computer system 100 and/or the replica server computer system 132. The client application 150-3 sends requests 154 that specify store operations (create, update, or delete) to the primary server 100. The application 150-3 may also send requests 154 that specify retrieve operations to either the primary server computer system 100 or the replica server computer system 132.

The replica server computer system 132 may include some or all of the components as previously described above for the primary server computer system 100. In particular, the replica server computer system 132 includes one or more processors 190 connected to memory 192. The memory 192 is a random access semiconductor memory or storage device that stores or encodes a local application 150-2 (local to the replica server computer system 132), a controller 152, a replica database 156-2, and a system flag table 158-2.

The local application 150-2 sends requests to the controller 152 at the replica server computer system 132. The local application 150-2 is local to the replica server computer system 132, in that the local application 150-2 is stored at the replica server computer system 132 and executes on the processor 190 at the replica server computer system 132. The requests sent by the local application 150-2 are retrieve operations, which instruct the controller 152 at the replica server computer system 132 to retrieve (find and read) data from the replica database 156-2 and send the retrieved data to the local application 150-2. In various embodiments, the replica database 156-2 may be a relational database or an object-oriented database. The controller 152 at the replica server computer system 132 may store both relational data and object data in a relational database. The controller 152 at the replica server computer system 132 may further store both relational data and object data in an object-oriented database. The system flag table 158-2 indicates whether data stored in the replica database 156-2 is stored as relational data or object data.

The controller 152 at the replica server 132 receives requests from the primary server 100 that include replicated changes (creates, updates, and deletes) that were previously made to the primary database 156-1 at the primary server 100 and performs the operations specified in the requests to make the replicated changes in the replica database 156-2. After all changes that were made to the primary database 156-1 are replicated and made to the corresponding replica database 156-2, the primary database 156-1 and its corresponding replica database 156-2 include identical data, although the data may have different formats, such as the primary database 156-1 storing particular data in the object format while the replica database 156-2 stores the same data in the relational format, and vice versa. In an embodiment, a primary database 156-1 may have multiple corresponding replica databases 156-2 that are stored on different replica servers 132. In another embodiment, a primary database 156-1 does not necessarily have a corresponding replica database 156-2, in which case changes made to the primary database 156-1 are not replicated.

The local application 150-2 and the controller 152 include instructions capable of executing on the processor 190 or statements capable of being interpreted by instructions executing on the processor 190 to perform the functions as further described below with reference to FIGS. 4, 5, and 6.

The database 156-1 has a mode of primary because the database 156-1 is stored at the primary server 100, which controls replication processes that replicate or copy all changes that occur at the primary database 156-1 stored at the primary server 100 into the replica servers 132 that store the corresponding replica databases 156-2. Both the primary server 100 and the replica servers 132 process data retrieval requests from clients 135 and from respective local applications 150-1 and 150-2 stored at their respective servers 100 and 132. But, the primary server 100 processes store (update, delete, and create) requests from its local application 150-1 and from the clients 135. The primary sever 100 then replicates (copies) the changes at the primary database 156-1 to the corresponding replica databases 156-2 that are stored at the replica servers 132. In contrast to the primary server 100, the replica server 132 does not process store (create, update, and delete) operations from its local application 150-2 or from the clients 135. In various embodiments, different databases may have different primary servers, and a particular server may act as a primary server for one database but act as a replica server for another database.

It should be understood that FIG. 1 is intended to depict the representative major components of the computer systems 100, 132, and 135 and the network 130 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer systems 100, 132, and 135, and that, when read and executed by one or more processors in the computer systems 100, 132, and 135, cause the computer systems 100, 132, and 135 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer systems 100, 132, and 135 via a variety of tangible signal-bearing media that may be operatively or communicatively connected (directly or indirectly) to the processor or processors, such as the processors 101 and 190. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102 or 192, CD-RW, or diskette; or

(3) information conveyed to the computer systems 100, 132, and/or 135 by a communications medium, such as through the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

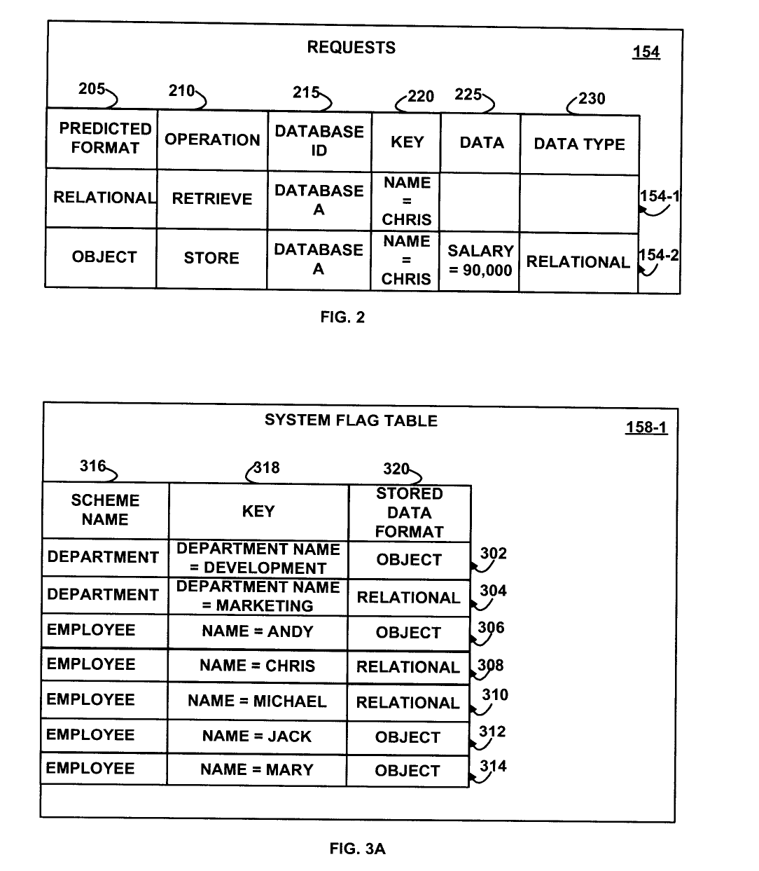

FIG. 2 depicts a high-level block diagram of an example data structure for the requests 154, according to an embodiment of the invention. FIG. 2 illustrates two example requests 154-1 and 154-2, each of which includes a predicted format field 205, an operation field 210, a database identifier field 215, a key field 220, a data field 225, and a data type field 230. The request 154 generically refers to either or both of the requests 154-1 and/or 154-2.

The predicted format field 205 specifies the future format of the data 225 that the controller 152 predicts is most likely to yield the best performance for accesses and replication of the respective data 225. The predicted format field 205 may specify a relational data format or an object data format. In various embodiments, the controller 152 determines the predicted format 205 based on the type of the requester (whether the requestor is a local application, a client application, an object-oriented application, or a procedural application); based on a mode of the local database (whether the local database is a primary database 156-1 or a replica database 156-2, i.e., whether the server computer system 100 or 132 at which the controller 152 executes is a primary server or a replica server with respect to the database 156-1 or 156-2 identified by the database identifier 215); based on whether changes made by the request (if the operation 210 is a store) to a primary database 156-1 need replication to a replica database 156-2, if such as replica database 156-2 exists; and based on whether more than a threshold percentage of historical requests received by the controller 152 were sent by local object-oriented applications.

The operation field 210 specifies an operation or command that the controller 152 that receives the request performs. Operations include store and retrieve operations. As used herein, a store operation refers to any or all of a create operation that adds new data to the database identified by the database identifier 215, an update operation that changes existing data in the database identified by the database identifier 215, and a delete operation that removes existing data from the database identified by the database identifier 215. A retrieve operation retrieves or obtains data from the database identified by the database identifier 215 and sends the data to the requestor that initiated the request 154.

The database identifier field 215 specifies a name or other identifier of a primary database 156-1 if the operation 210 specifies a create operation. The database identifier field 215 specifies a name or other identifier of either a primary database 156-1 or a replica database 156-2 if the operation 210 specifies a retrieve operation. The key field 220 uniquely identifies the data on which the operation operates. In an embodiment, the key field 220 specifies a field or column in the database 215 and a value that is stored (for a retrieve, update, or delete operation) or is to be stored (for a create operation) in the database identified by the database identifier 215. For a create or update operation, the data field 225 includes the data that is to be created or changed in the column or field (specified by the key 220) in the database identified by the database identifier 215. The data type field 230 specifies the format of the data 225 as it exists in the request 154. The data type field 230 may specify a relational data format or an object oriented data format.

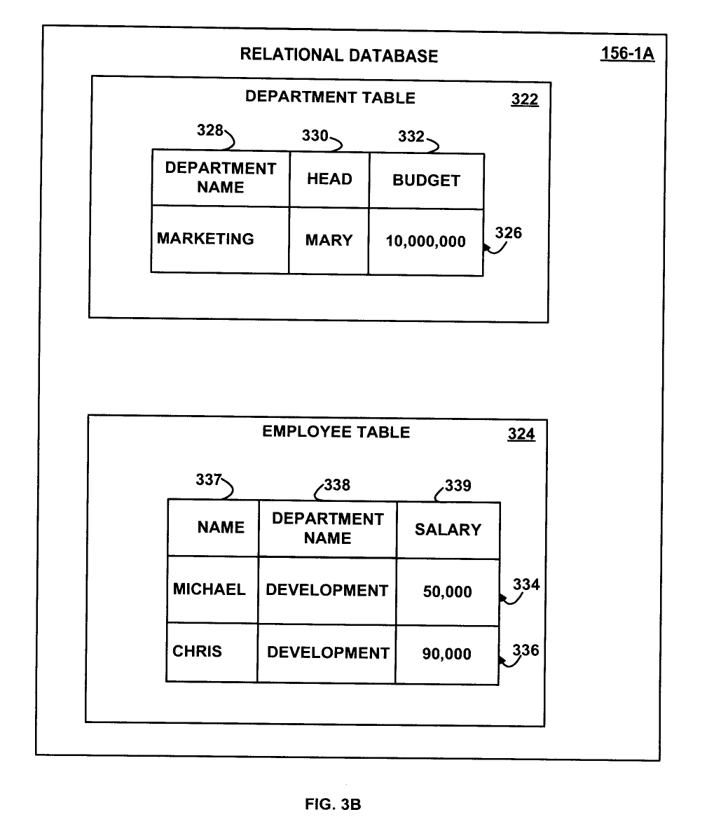

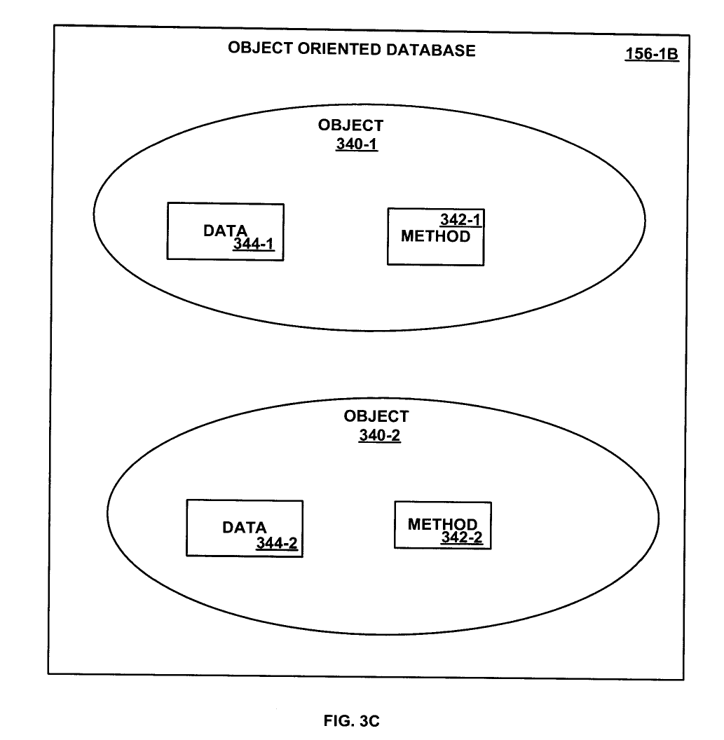

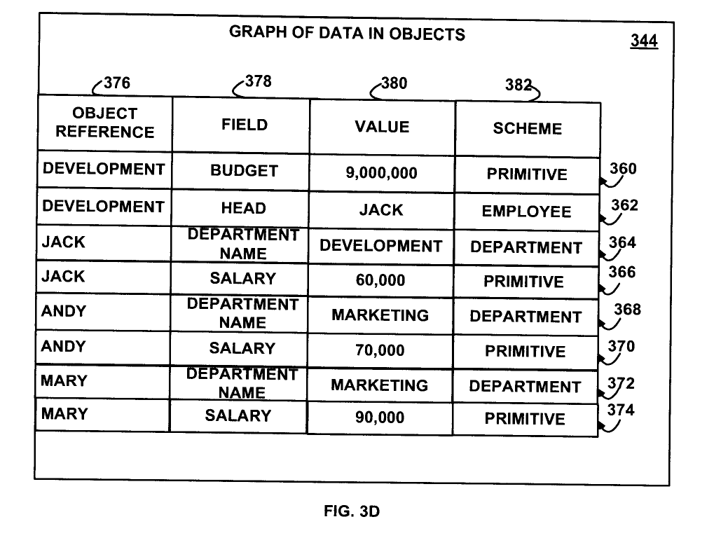

FIG. 3A depicts a high-level block diagram of an example system flag table 158-1, according to an embodiment of the invention. The system flag table 158-1 includes example records 302, 304, 306, 308, 310, 312, and 314, each of which includes a scheme name field 316, a key field 318, and a stored data format field 320. The scheme name field 316 specifies a table in a relational database or an object in an object oriented database. The key field 318 specifies a column or field and a value stored in the column or field in the scheme 316. The stored data format 320 specifies the format of the data value of the key 318 in the scheme 316. Example stored data formats are an object format and a relational format.

As indicated in FIG. 3A, the same scheme 316 may have data stored in a variety of stored data formats 320. For example, as indicated in the record 302, the scheme 316 of “department” includes data values indicated by the key 318 that are stored in the object format, as indicated by the respective stored data format 320. Yet, as indicated in the record 304, the scheme 316 of “department” also includes data values indicated by the respective key 318 that are stored in the relational format, as indicated by the respective stored data format 320.

As indicated in FIG. 3A, different values in the same field may be stored with different stored data formats 320. For example, as indicated in the record 302, the key 318 that specifies a department name field has its value of “development” stored in the object data format 320. Yet, as indicated in the record 304, the respective key 318 that also specifies a department name field has its value of “marketing” stored in the relational data format 320.

In response to retrieve requests, the controller 152 uses the system flag table 158-1 to determine whether to retrieve the data for a key from an object oriented database or a relational database. The controller 152 finds the record in the system flag table that has a key 318 that matches the key 220 of the request 154 and discovers whether the scheme 316 associated with the key has a stored data format 320 of object or relational.

The system flag table 158-2 (FIG. 1) may have the same or different data as the system flag table 158-1, depending on the formats in which the replicated data is stored at the replica server 132.

FIG. 3B depicts a high-level block diagram of an example data structure for data in a relational data format, according to an embodiment of the invention. The database 156-1 (FIG. 1) includes or generically refers to the relational data format 156-1 A. The relational database 156-1A includes tables 322 and 324. The table 322 is a department table and is identified by the scheme name 316 of “department” and the stored data format 320 of “relational.” (FIG. 3A). The department table 322 includes a record 326, which includes a department name field 328, a head field 330, and a budget field 332. The record 326 is also called a row or a tuple. The fields 328, 330, and 332 may also be referred to as columns or keys. The record 304 in the system flag table 158-1 (FIG. 3A) indicates that for the scheme 316 of “department name,” with a key 318 of a department name field and a value of “marketing,” the data is stored in a stored data format 320 of a relational format, so the record 326 includes data in a relational format for the marketing department. The department table 322 in the relational database 156-1 A does not include a record for the development department because the system flag table 158-1 indicates, in the record 302, that the development value for the department name field is stored in an object data format.

The table 324 is an employee table and is identified by the scheme name 316 of “employee” and the stored data format 320 of“relational.” The employee table 324 includes records 334 and 336, each of which includes a name field 337, a department name field 338, and a salary field 339. The records 334 and 336 are also called rows or tuples. The fields 337, 338 and 339 may also be referred to as columns or keys. The record 310 in the system flag table 158-1 (FIG. 3A) indicates that for the scheme 316 of “employee,” with a key 318 of a name field and a value of “Michael,” the data value is stored in a stored data format 320 of a relational format in an employee scheme, so the record 334 includes a data value in a relational format for the employee with a name of “Michael.” The record 308 in the system flag table 158-1 (FIG. 3A) indicates that for the scheme 316 of “employee,” with a key 318 of a name field and a value of “Chris,” the data value is stored in a stored data format 320 of a relational format in an employee scheme, so the record 336 includes a data value in a relational format for the employee with a name of “Chris” in the employee table 324.

The employee table 324 in the relational database 156-IA does not include records for the employees with names of Andy, Jack, and Mary because the system flag table 158-1 indicates, in respective records 306, 312, and 314, that the values of Andy, Jack, and Mary are stored in name fields in the employee scheme in the object data format, and the employee table 324 only stores data values for the employee scheme in the relational format.

FIG. 3C depicts a high-level block diagram of an example object oriented data format 156-1B, according to an embodiment of the invention. The database 156-1 (FIG. 1) includes or generically refers to the object oriented data format 156-1B in addition to the relational data format 156-1A, as previously described above.

The object oriented data format 156-1B, includes objects 340-1 and 340-2. The object 340-1 encapsulates a method 342-1 and a data member 344-1. Encapsulation means that the data in the data member 344-1 is accessed through the object 340-1 via messages sent to the method 342-1 or invocations of the method 342-1. The object 340-2 encapsulates a method 342-2 and a data member 344-2. The data in the data member 344-2 is accessed through the object 340-2 via messages sent to the method 342-2 or invocations of the method 342-2. The data members 344-1 and 344-2 are further described below with reference to FIG. 3D.

An object oriented database 156-1B is used in an object-oriented programming model, in which a computer program comprises a collection of objects that act on each other, as opposed to a procedural program that is a collection of functions or a list of instructions. The objects 340-1 or 340-2 are capable of receiving messages, performing methods, and sending messages to other objects. Each object can be viewed as an independent machine with a distinct role.

The objects 340-1 and 340-2 are instantiations of, or particular instances of, classes. A class defines the abstract characteristics of an object, including the object's characteristics (its attributes or properties) and the methods that the object can perform. Classes provide modularity and structure in an object-oriented computer program. Collectively, the properties and methods defined by a class are called members. The set of values of the attributes of a particular object is called the state of the object.

The methods 342-1 and 342-2 are their objects' abilities or actions and are implemented as code or instructions capable of being executed by a processor or statements capable of being interpreted by instructions that execute on a processor. Message passing is the process by which an object sends data to another object or requests the other object to invoke one of its methods.

Encapsulation conceals the exact details of how a particular class works from objects that use its code or send messages to it. Encapsulation is achieved by specifying which classes may use the members of an object. The result is that each object exposes to any class a certain interface: those members accessible to that class. Data is said to be encapsulated within an object because the data may only be accessed by invoking the methods of the object.

Objects exist only within contexts that are aware of them, and a piece of computer memory only holds an object if a program treats it as an object (for example by reserving it for exclusive use by specific procedures and/or associating a data type with it). Thus, the lifetime of an object is the time during which it is treated as an object.

FIG. 3D depicts a high-level block diagram of an example graph of data 344 in the object oriented database, according to an embodiment of the invention. The graph of the data 344 generically refers to the data members 344-1 and 344-2 of FIG. 3C. The graph 344 includes example nodes 360, 362, 364, 366, 368, 370, 372, and 374, each of which includes an object reference 376, a field 378, a value 380, and a scheme 382. The object reference 376 specifies an object, such as the object 340-1 or 340-2. The nodes 360 and 362 illustrate an object reference 376 of a “development” object, and the nodes 364, 366, 368, 370, 372, and 374 illustrate various employee object references for the object reference 376.

The field 378 specifies a field name in the data member of the respective object, such as a field name in the data members 344-1 or 344-2. The value 380 specifies a value in the respective field 378. The scheme field 382 specifies the relationship of the respective value 380 in the respective field 378 in the respective object 376 to another object (specified in the scheme 382). A combination of a value 380 in a field 378 in an object 376 that does not have a relationship to another object is identified by “primitive” in the respective scheme 382, as illustrated in the nodes 360, 366, 370, and 374.

For example, the node 360 specifies that a field 378 named “budget” in the development object 376 includes a value 380 of “9,000,000”, and that field with that value in that object is not related to other objects.

As another example, the node 362 specifies that a field 378 named “head” in the development object 376 includes a value 380 of “Jack,” and the value of “Jack” also exists in a scheme 382 named “employee,” which refers to an object named “employee” containing the value “Jack” because the record 312 in the system flag table 158-1 indicates that “Jack” exists in a name field in the employee scheme in the stored data format 320 of the object format. Thus, the value of “Jack” in the “head” field 378 in the “development” object 376 has a relationship to the “employee” scheme 382.

As another example, the node 364 specifies that a field 378 named “department name” in the “Jack” object 376 includes a value 380 of “development”, and “development” also exists in a scheme 382 named “department,” which refers to an object named “department” containing the value “development” because the record 302 in the system flag table 158-1 indicates that “development” exists in a department name field in the department scheme in a stored data format 320 of an object format. Thus, the value of “development” in the “department name” field 378 in the “Jack” object 376 has a relationship to the “department” scheme 382.

As another example, the node 366 specifies that a field 378 named “salary” in the “Jack” object 376 includes a value 380 of “60,000”, and that field with that value in that object is not related to other objects.

As another example, the node 368 specifies that a field 378 named “department name” in the “Andy” object 376 includes a value 380 of “marketing”, and “marketing” also exists in a scheme 382 named “department,” which refers to a relational database having a field containing the value “marketing” because the record 304 in the system flag table 158-1 indicates that “marketing” exists in a department name field in the department scheme in a stored data format 320 of a relational object. Thus, the value of “marketing” in the “department name” field 378 in the “Andy” object 376 has a relationship to the “department” scheme 382.

As another example, the node 370 specifies that a field 378 named “salary” in the “Andy” object 376 includes a value 380 of “70,000”, and that field with that value in that object is not related to other objects.

As another example, the node 372 specifies that a field 378 named “department name” in the “Mary” object 376 includes a value 380 of “marketing”, and “marketing” also exists in a scheme 382 named “department,” which refers to a record in a relational database having a field containing the value “marketing” because the record 304 in the system flag table 158-1 indicates that “marketing” exists in a department name field in the department scheme in a stored data format 320 of a relational format. Thus, the value of “marketing” in the “department name” field 378 in the “Mary” object 376 has a relationship to the “department” scheme 382.

As another example, the node 374 specifies that a field 378 named “salary” in the “Mary” object 376 includes a value 380 of “90,000”, and that field with that value in that object is not related to other objects.

An object oriented database may include data in a relational format. For example, as indicated in the record 308 (FIG. 3A), the employee Chris stored in the employee scheme in an relational format (e.g., the relational employee table 324). Yet, the relational employee table 324 includes a department name field 338 including the value of “development,” which according to the record 302 in the system flag table 158-1, is stored in the object format, as indicated in the stored data format 320 of the record 302 and as illustrated in nodes 360 and 362 of the graph of data in objects 344 (FIG. 3D).

As an opposite example, a relational database may include data in an object format. For example, as indicated in the record 306 (FIG. 3A), node 368, and node 370, Andy is stored in the object format in the employee scheme. Yet, as indicated in the node 368, Andy is also stored in the marketing department (the value 380 and the scheme 382), and the marketing department is stored in the relational format, as indicated in the record 304 (FIG. 3A) and as illustrated in the record 326 of the department table 322 (FIG. 3B).

FIG. 4 depicts a flowchart of example processing for requests, according to an embodiment of the invention. Control begins at block 400. Control then continues to block 405 where the controller 152 receives a request 154 from a requester. In an embodiment, the received request specifies at least an operation, a key, and a database that is local to the controller 152 that receives the request, i.e., the local database is stored at or is connected to the same computer system as the processor on which the controller 152 executes. In various embodiments, the controller 152 may execute at either a primary server 100 or a replica server 132. In various embodiments, a requestor may be a local application (an application that is local to the controller 152 that receives the request), the client application 150-3, or a remote controller, which is another controller at another server, which may be either a primary server or a replica server. The controller 152 that receives the request may execute at a primary server 100 or a replica server 132.

Control then continues to block 410 where the controller 152 that received the request 154 determines the type of the requester that sent the request 154. If the type of the requester is a local object-oriented application, then control continues to block 415 where the controller 152 determines the predicted format for the data identified by the key 220 to be an object format and writes a specification of the object format into the predicted format field 205 of the request 154. Thus, the controller 152 determines the predicted format for the data based on the type of the requester.

A requester has an object oriented type if the requester is an application that includes a collection of objects that act on each other, as opposed to a procedural program that is a collection of functions or a list of instructions. The objects are capable of receiving messages, performing methods, and sending messages to other objects. Each object can be viewed as an independent machine with a distinct role. The objects are instantiations of, or particular instances of, classes. A class defines the abstract characteristics of an object, including the object's characteristics (its attributes or properties) and the methods that the object can perform. Classes provide modularity and structure in an object-oriented computer program or application. Collectively, the properties and methods defined by a class are called members. The set of values of the attributes of a particular object is called the state of the object. The methods are their objects' abilities or actions and are implemented as code or instructions capable of being executed by a processor or statements capable of being interpreted by instructions that execute on a processor. Message passing is the process by which an object sends data to another object or requests the other object to invoke one of its methods. Encapsulation conceals the exact details of how a particular class works from objects that use its code or send messages to it. Encapsulation is achieved by specifying which classes may use the members of an object. The result is that each object exposes to any class a certain interface: those members accessible to that class. Data is said to be encapsulated within an object because the data may only be accessed by invoking the methods of the object. Objects exist only within contexts that are aware of them, and a piece of computer memory only holds an object if a program treats it as an object (for example by reserving it for exclusive use by specific procedures and/or associating a data type with it). Thus, the lifetime of an object is the time during which it is treated as an object.

Control then continues to block 420 where the controller 152 that received the request 154 determines whether the local database (the database that is stored at the same server on which the controller 152 executes) has a mode of a primary database, whether the operation field 210 specifies a store operation, whether a corresponding replica database 156-2 exists for the database identified by the database identifier 215 in the request 154, and whether the operation needs replication from the primary database to the replica database 156-2. If the determination at block 420 is true, then the operation needs replication from the primary database 156-1 that is local to a corresponding replica database 156-2, so control continues to block 425 where the controller 152 determines the predicted format 205 for the data identified by the key 220 to be a relational format (over-writing any previously predicted format value that may already exist in the request 154). Thus, the controller 152 determines the predicted format for the data based on the mode (primary or replica) of the local database.

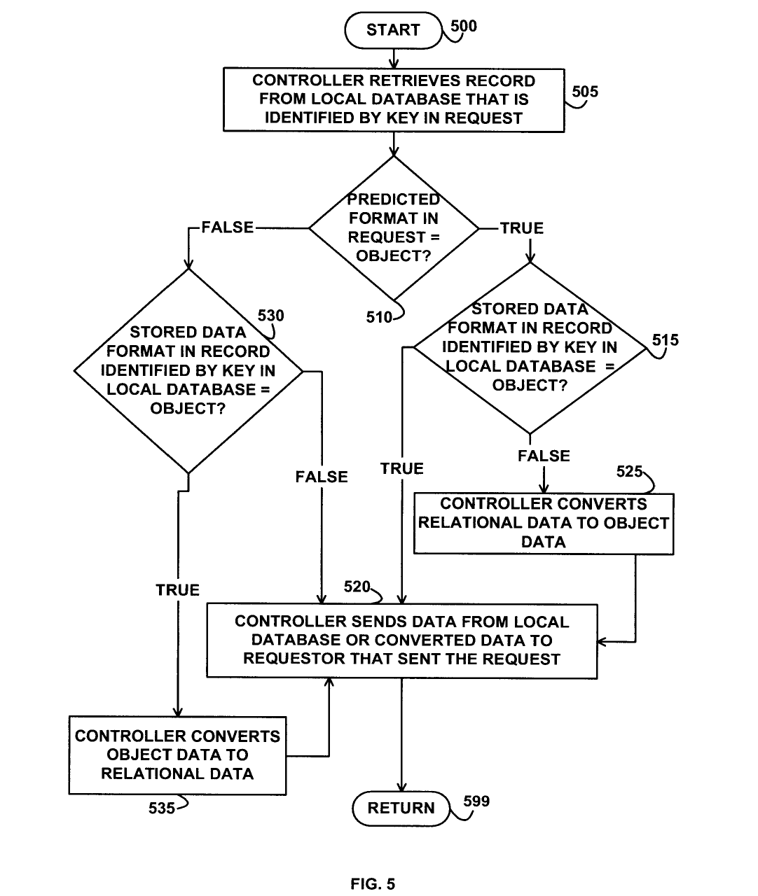

Control then continues to block 430 where the controller 152 determines whether the operation field 210 in the received request 154 specifies a retrieve operation. If the determination at block 430 is true, then the operation specified by the operation field 210 in the request 154 is a retrieve operation, so control continues to block 435 where the controller 152 processes the retrieve operation, as further described below with reference to FIG. 5. Control then continues to block 499 where the logic of FIG. 4 returns.

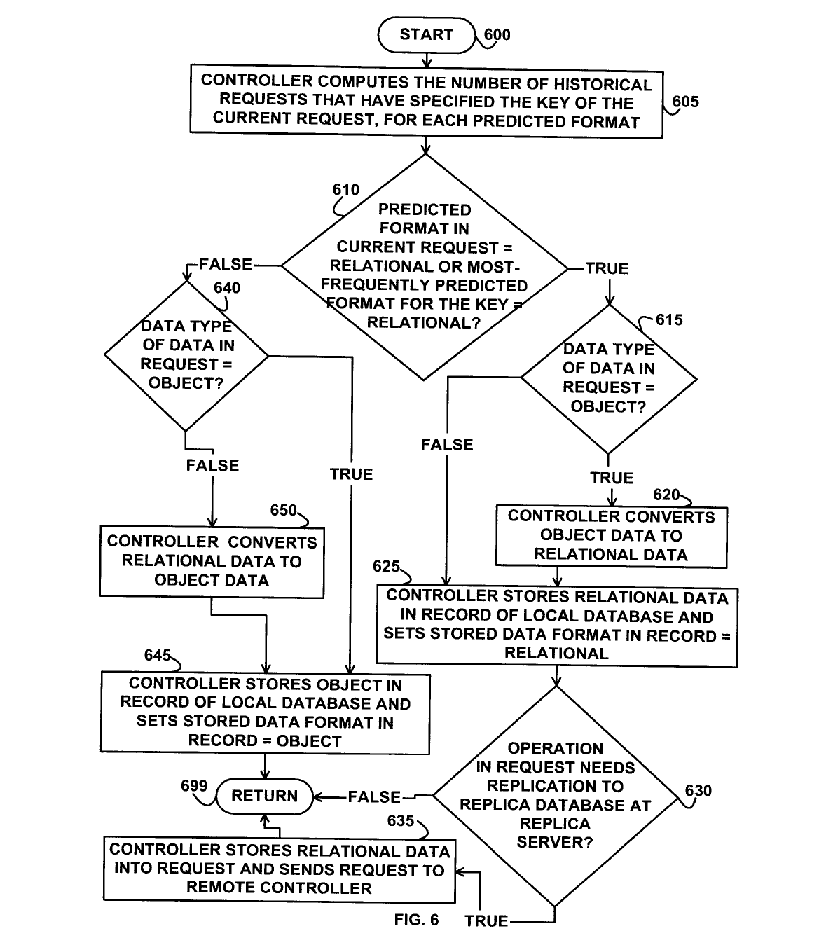

If the determination at block 430 is false, then the operation specified by the operation field 210 in the request 154 is a store (create, update, or delete) operation, so control continues to block 440 where the controller 152 processes the store operation, as further described below with reference to FIG. 6. Control then continues to block 499 where the logic of FIG. 4 returns.

If the determination at block 420 is false, then the operation does not need replication (the replica database does not exist) or the local database is a replica database 156-2, so control continues to block 430 where the controller 152 determines whether the operation field 210 in the received request 154 specified a retrieve operation, as previously described above. (If the determination at block 420 is false, then the predicted format, which was previously set to specify the object format at block 415, is not altered. Thus, if the requestor has a type of a local object oriented application and replication is not needed, then the predicted format is determined to be the object format. Further, if more than a threshold percentage of received requests are from a plurality of requestors having the type of the local object-oriented application and the mode is the primary database and replication of the operation is not needed, the predicted format is determined to be the object format.)

If the determination at block 410 is false, then the requester is not an object-oriented application local to the controller 152, so either the requestor is a client application 150-3 at the client 135, the requestor is a local application that has a type of procedural, or the requester is another controller at another server different from the server that received the request (at block 405), so control continues to block 445 where the controller 152 determines whether more than a threshold percentage number of historical requests received by the controller 152 were from requestors that were local object-oriented applications (requesters that had a type of local object-oriented application) and the local database specified by the database identifier 215 in the current request 154 is a primary database (the mode of the local database is a primary database).

If the determination at block 445 is true, then more than a threshold percentage amount of historical requests previously received by the controller 152 were from requesters that were local object-oriented applications (requesters that have a type of local object-oriented application) and the local database specified by the database identifier 215 in the current request 154 (received at block 405) is a primary database (the mode of the local database is a primary database), so control continues to block 415 where the controller 152 determines the predicted format 205 for the data identified by the key 220 in the current request 154 to be an object format and writes a specification of the object format into the predicted format field 205 of the request, as previously described above.

If the determination at block 445 is false, then less than or equal to a threshold percentage number of historical requests received by the controller 152 were from requestors that were local object-oriented applications (requestors that have a type of local object-oriented application) or the local database specified by the database identifier 215 in the current request 154 is a replica database 156-2 (the mode of the local database is a replica database 156-2), so control continues to block 425 where the controller 152 determines the predicted format 205 for the data identified by the key 220 to be the relational format (over-writing any previously predicted format value that may already exist in the predicted format field 205 of the current request 154), as previously described above. The controller 152 writes a specification of the relational format into the predicted format field 205 of the request 154. Control then continues to block 430, as previously described above.

FIG. 5 depicts a flowchart of example processing for retrieve operations, according to an embodiment of the invention. Control begins at block 500. Control then continues to block 505 where the controller 152 searches for and finds the record, field, or data item in the local database 156-1 or 156-2 that is identified by the database identifier 215 and the key 220 in the request 154. If the local database is an object oriented database, the controller 152 accesses the data in the local database via invoking the methods of the object that encapsulates the data, e.g., the object 340-1 or 340-2 and the respective methods 342-1 or 342-2.

Control then continues to block 510 where the controller 152 determines whether the predicted format 205 in the request 154 for the data specifies the object format. If the determination at block 510 is true, then the predicted format 205 is an object format, so control continues to block 515 where the controller 152 determines whether the stored data format 320 in the record in the system flag table that has a key 318 that matches the key 220 that was retrieved from the local database specifies that the data in the record identified by the key 220 is stored in an object format, i.e., the controller 152 determines whether the predicted format 205 for the key 220 and the stored data format 320 for the key 318 that matches the key 220 are identical and whether that identical format is the object format. If the determination at block 515 is true, then the stored data format 320 of the data that was retrieved from the database specifies the object format and the retrieved data is already formatted in the predicted format 205 (the object format), so control continues to block 520 where the controller 152 sends the retrieved data in the object format (which is the predicted format 205) to the requestor from which the request 154 was received. Control then continues to block 599 where the logic of FIG. 5 returns.

If the determination at block 515 is false, then the stored format 320 of the data that was retrieved from the database is a relational format and the predicted format 205 and the stored data format 320 are different (the predicted data format 205 specifies an object data format), so control continues to block 525 where the controller 152 converts the data that was retrieved from the database from the relational format to the object format. Control then continues to block 520 where the controller 152 sends the converted data in the object format (which is the predicted format 205) to the requester from which the request 154 was received. Control then continues to block 599 where the logic of FIG. 5 returns.

If the determination at block 510 is false, then the predicted format 205 specifies the relational format, so control continues to block 530 where the controller 152 determines whether the stored data format 320 in the record in the system flag table that has a key 318 that matches the key 220 that was retrieved from the local database specifies that the data in the record identified by the key 220 is stored in an object format. If the determination at block 530 is true, then the stored format of the data that was retrieved from the database specifies the object format, and the predicted format 205 and the stored data format 320 of the data are different (the predicted format 205 for the key 220 specifies a relational format and the stored format 320 for the same key 318 specifies an object format), so control continues to block 535 where the controller 152 converts the data that was retrieved from the database from the object format into the relational format (the predicted format).

Control then continues to block 520 where the controller 152 sends the converted data in the relational format (the predicted format 205) to the requester from which the request 154 was received. Control then continues to block 599 where the logic of FIG. 5 returns.

If the determination at block 530 is false, then the stored format of the data that was retrieved from the database is in a relational format and the predicted format 205 and the stored data format 320 are identical, so control continues to block 520 where the controller 152 sends the retrieved data in the relational formal (the predicted format 205) to the requestor from which the request 154 was received. Control then continues to block 599 where the logic of FIG. 5 returns.

FIG. 6 depicts a flowchart of example processing for store operations, according to an embodiment of the invention. Control begins at block 600. Control then continues to block 605 where the controller 152 computes or counts a number (an object number) of historical requests that specified the same key as the key 220 in the request 154 and for which the predicted format 205 was the object format. The controller 152 further computes or counts a number (a relational number) of historical requests that specified the same key as the key 220 in the request 154 and for which the predicted format 205 was the relational format. The controller 152 then compares the object number and the relational number and chooses the larger of the object number and the relational number, in order to the determine the most-frequently predicted historical format for previous requests that specified the same key as the key 220 in the current request. If the object number is larger, then the most-frequently predicted historical format for previous requests that specified the same key as the key 220 in the current request is the object format. If the relational number is larger, then the most-frequently predicted historical format for previous requests that specified the same key as the key 220 in the current request is the relational format.

Control then continues to block 610 where the controller 152 determines whether the predicted format 205 in the current request is the relational format or the most-frequently predicted historical format for historical requests that specified the same key as the current key 220 is the relational format. If the determination at block 610 is true, then the predicted format 205 in the current request is the relational format or the most-frequently predicted historical format for historical requests that specified the same key as the current key 220 is the relational format (the relational number is larger than the object number), so control continues to block 615 where the controller 152 determines whether the data type 230 in the request 154 specifies that the data 225 in the request 154 is formatted in the object format.

If the determination at block 615 is true, then the data 225 in the request 154 is formatted in the object format, so control continues to block 620 where the controller 152 converts the data 225 in the request 154 from the object format into the relational format. Control then continues to block 625 where the controller 152 stores the relational data in a record in the local database and sets the stored data format 320 in the record in the system flag table 158-1 that has a key 318 that matches the key 220 to indicate that the data is stored in the relational format. Thus, the controller 152 stores the data in the local database in the predicted format 205, unless overruled by the historical predicted format of requests that used the same key, regardless of what format the data had in the request 154 and regardless of whether the local database is an object oriented database or a relational database.

Control then continues to block 630 where the controller 152 determines whether a replica database 156-2 at a replica server 132 exists that corresponds to the local database and whether the operation specified by the received store request 154-2 needs replication to the replica server 132. If the determination at block 630 is true, then a replica database 156-2 at a replica server 132 exists that corresponds to the local database and the operation needs replication to the replica server 132, so control continues to block 635 where the controller 152 stores the data in the relational format into the request 154, sets the data type 230 to indicate that the data 225 is in the relational format, and sends the request 154 to the replica server 132 that manages the replica database 156-2 that corresponds to the local database. The replica server 132 receives and processes the request, as previously described above with reference to FIG. 4 (in a different invocation of the logic of FIG. 4). Control then continues to block 699 where the logic of FIG. 6 returns.

If the determination at block 630 is false, then a replica database at a replica server does not exist that corresponds to the local database or the operation does not need replication to a replica server, so control continues to block 699 where the logic of FIG. 6 returns.

If the determination at block 615 is false, then the data 225 in the request 154 is formatted in the relational format (the data type 230 specifies a relational format), so control continues to block 625 where the controller 152 stores the relational data in a record in the local database and sets the stored data format 320 in the record in the system flag table that has a key 318 that matches the key 220 to indicate that the data is stored in the record in the relational format. Thus, the controller 152 stores the data in the local database in the predicted format 205, which in this case is the same as the format of the data in the request 154. Control then continues to block 630, as previously described above.

If the determination at block 610 is false, then the predicted format 205 in the current request is the object format and the most-frequently predicted historical format for historical requests that specified the same key as the current key is the object format (the object number is greater than or equal to the relational number), so control continues to block 640 where the controller 152 determines whether the data type 230 in the request 154 specifies that the data 225 in the request 154 is formatted in the object format.

If the determination at block 640 is true, then the data 225 in the request 154 is formatted in the object format, so control continues to block 645 where the controller 152 stores the data in the object format in a record in the local database and sets the stored data format 320 in the record in the system flag table that has a key 318 that matches the key 220 to indicate that the data is stored in the record in the object format. Thus, the controller 152 stores the data in the database in the predicted format 205, which in this case is the same as the format the data had in the request 154, regardless of whether the local database is an object oriented database or a relational database. Control then continues to block 699 where the logic of FIG. 6 returns.

If the determination at block 640 is false, then the data in the request 154 is formatted in the relational format, so control continues to block 650 where the controller 152 converts the data in the request 154 from the relational format into the object format. Control then continues to block 645 where the controller 152 stores the converted data in the object format into a record in the local database and sets the stored data format 320 in the record in the system flag table that has a key 318 that matches the key 220 to indicate that the data is stored in the local database in the object format. Thus, the controller 152 stores the data in the local database in the predicted format 205, regardless of what format the data had in the request 154 and regardless of whether the local database is an object oriented database or a relational database. Control then continues to block 699 where the logic of FIG. 6 returns.

Thus, the combination of the logic of FIGS. 5 and 6 determines a predicted format 205, sends retrieved data to the requestor in that predicted format 205, and stores data in a local database in that predicted format, regardless of in which format the data is stored.

The controller 152 converts data from the object format to the relational format via a technique called object serialization, which converts an object into a serial sequence of bytes (a byte stream). Serializing an object is also called deflating an object or marshalling an object. This byte stream can later be restored to regenerate the original object, or to create a new object that is identical in its internal state to the original object, through a process called de-serialization, which is also known as inflating or un-marshalling an object.

Serialization breaks the opacity of an abstract data type in the object by exposing implementation details of the object and allows access to persistent private members of a class that are not otherwise accessible. In an embodiment, an encoding method for serialization translates fields in the object into a byte stream, encodes primitives into the byte stream, and encodes persistent, non-static referenced objects into the stream. In addition, each persistent object that is referenced by the serialized object is also serialized into the byte stream. Persistent objects and members are those objects and members whose lifetime is not bound to the lifetime of the process that created them. The lifetime of persistent objects is arbitrary, determined by an application, and their state is kept in a nonvolatile data store. From that persistent store, the objects can be restored when needed. The counterparts of persistent objects are transient objects, the lifetime of which are limited by the lifetime of the creating process. In an embodiment, the serialization process stores, in the byte stream, each field or piece of data within the object and precedes the field by a tag that defines the type and length of the field.

When de-serializing the serial byte stream into the object format, the controller 152 program reads the tags in the byte stream, then reads in ten characters and assigns them to a string. The controller 152 then reads the next tag and reconstructs an object that is appropriate to the data that follows the tag.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving a first request from a requester, wherein the first request comprises first data and a specification of a store operation, a first key, and a local database;
determining a predicted format for the first data based on a type of the requester and a mode of the local database, wherein the mode is selected from a group consisting of a primary database and a replica database; and
if the predicted format is a relational format, storing the first data into the local database in the relational format.

2. The method of claim 1, further comprising:
calculating a most-frequently predicted historical format for a plurality of historical requests that comprised a same key as the first key; and
if the most-frequently predicted historical format is the relational format, storing the first data into the local database in the relational format.

3. The method of claim 2, further comprising:
if both the predicted format and the most-frequently predicted historical format are an object format, storing the first data into the local database in the object format.

4. The method of claim 3, wherein the storing the first data into the local database in the object format further comprises:
if the first data is in a relational format, converting the first data into the object format.

5. The method of claim 1, wherein the determining further comprises:
if the type of the requester comprises a local object-oriented application and the mode is the primary database and replication of the operation is not needed, determining the predicted format to be an object format.

6. The method of claim 1, wherein the determining further comprises:
if more than a threshold percentage of received requests are from a plurality of requesters having the type of the local object-oriented application and the mode is the primary database and replication of the operation is not needed, determining the predicted format to be an object format.

7. The method of claim 1, wherein the storing the first data into the local database in the relational format further comprises:
if the first data is in an object format, converting the first data into the relational format.

8. A signal-bearing medium encoded with instructions, wherein the instructions when executed on a processor comprise:
receiving a first request from a requestor, wherein the first request comprises first data and a specification of a store operation, a first key, and a local database;
determining a predicted format for the first data based on a type of the requester and a mode of the local database, wherein the mode is selected from a group consisting of a primary database and a replica database;
if the predicted format is a relational format, storing the first data into the local database in the relational format; and
if a most-frequently predicted historical format, for a plurality of historical requests that comprised a same key as the first key, is the relational format, storing the first data into the local database in the relational format.

9. The signal-bearing medium of claim 8, further comprising:
if both the predicted format and the most-frequently predicted historical format are an object format, storing the first data into the local database in the object format.

10. The signal-bearing medium of claim 9, wherein the storing the first data into the local database in the object format further comprises:
if the first data is in a relational format, converting the first data into the object format.

11. The signal-bearing medium of claim 8, wherein the determining further comprises:
if the type of the requester comprises a local object-oriented application and the mode is the primary database and replication of the operation is not needed, determining the predicted format to be an object format.

12. The signal-bearing medium of claim 8, wherein the determining further comprises:
if more than a threshold percentage of received requests are from a plurality of requesters having the type of the local object-oriented application and the mode is the primary database and replication of the operation is not needed, determining the predicted format to be an object format.

13. The signal-bearing medium of claim 8, wherein the storing the first data into the local database in the relational format further comprises:
if the first data is in an object format, converting the first data into the relational format.

14. The signal-bearing medium of claim 8, further comprising:
receiving a second request from a second requester, wherein the second request comprises a specification of a retrieve operation, the first key, and the local database;
retrieving the first data from the local database based on the first key;
determining a second predicted format for the first data based on a type of the second requester and the mode of the local database;
if the second predicted format is the relational format, sending the first data to the requester in the relational format; and
if the second predicted format is an object format, sending the first data to the requester in the object format.

15. The signal-bearing medium of claim 14, wherein the sending the first data to the requestor in the relational format further comprises:
if the first data is in the object format, converting the first data into the relational format.

16. The signal-bearing medium of claim 14, wherein the sending the first data to the requestor in the object format further comprises:
if the first data is in the relational format, converting the first data into the object format.

17. A computer system comprising:
a processor; and
memory connected to the processor, wherein the memory encodes instructions that when executed by the processor comprise:
receiving a first request from a requestor, wherein the first request comprises first data and a specification of a store operation, a first key, and a local database,
determining a predicted format for the first data based on a type of the requestor and a mode of the local database, wherein the mode is selected from a group consisting of a primary database and a replica database,
if the predicted format is a relational format, storing the first data into the local database in the relational format,
if a most-frequently predicted historical format, for a plurality of historical requests that comprised a same key as the first key, is the relational format, storing the first data into the local database in the relational format, and
if both the predicted format and the most-frequently predicted historical format are an object format, storing the first data into the local database in the object format.

18. The computer system of claim 17, wherein the storing the first data into the local database in the object format further comprises:
if the first data is in a relational format, converting the first data into the object format.

19. The computer system of claim 17, wherein the determining further comprises:
if the type of the requestor comprises a local object-oriented application and the mode is the primary database and replication of the operation is not needed, determining the predicted format to be an object format.

20. The computer system of claim 17, wherein the instructions further comprise:
receiving a second request from a second requester, wherein the second request comprises a specification of a retrieve operation, the first key, and the local database;
retrieving the first data from the local database based on the first key;
determining a second predicted format for the first data based on a type of the second requestor and the mode of the local database;
if the second predicted format is the relational format, sending the first data to the requestor in the relational format; and
if the second predicted format is an object format, sending the first data to the requester in the object format.
